(19) United States
(12) Patent Application Publication
(10) Pub. No.: US 2025/0066524 A1
(43) Pub. Date: Feb. 27, 2025

(54) HIGH INTERNAL PHASE POLYMERS FOR PFAS ABSORPTION

(71) Applicant: The Government of the United States of America, as represented by the Secretary of the Navy, Arlington, VA (US)

(72) Inventors: Grant C. Daniels, Burke, VA (US); Meghanne E. Tighe, Falls Church, VA (US); Matthew D. Thum, Annapolis, MD (US); Nickolaus K. Weise, Alexandria, VA (US)

(73) Assignee: The Government of the United States of America, as represented by the Secretary of the Navy, Arlington, VA (US)

(21) Appl. No.: 18/812,134

(22) Filed: Aug. 22, 2024

Related U.S. Application Data
(60) Provisional application No. 63/578,083, filed on Aug. 22, 2023.

(51) Int. Cl. C08F 220/28; B01J 20/26; C08F 2/22

(52) U.S. Cl. CPC C08F 220/286; B01J 20/261; C08F 2/22

(57) ABSTRACT

Disclosed herein is a compound made by copolymerizing a poly(ethylene glycol) acrylate with a first acrylate monomer having a first functional group that interacts with a third functional group having a third functional group type selected from anionic groups, cationic groups, or perfluoroalkyl groups. Optionally, the copolymerization includes a second acrylate monomer having a second functional group that interacts with a fourth functional group having a fourth functional group type selected from anionic groups, cationic groups, and perfluoroalkyl groups. The third functional group type and the fourth functional group type are different. When the compound is porous, as when made by high internal phase emulsion polymerization, it may be used for per- and poly-fluoro alkyl substance decontamination.

### REFERENCE TO RELATED APPLICATIONS

This application claims the benefit of U.S. Provisional Application No. 63/578,083, filed on Aug. 22, 2023. The provisional application and all other publications and patent documents referred to throughout this nonprovisional application are incorporated herein by reference.

### TECHNICAL FIELD

The present disclosure is generally related to per- and poly-fluoro alkyl substance decontamination.

### DESCRIPTION OF THE RELATED ART

PFAS are a class of more than 5,000 compounds containing a carbon chain, of any length, saturated with fluorine atoms instead of hydrogen atoms, and containing a polar end group. Due to their hydrophobic tail and hydrophilic end group, these compounds make excellent surfactants and are used in a wide variety of consumer products, such as aqueous fire-fighting foams, non-stick cookware, cosmetics, etc. Due to their widespread use, they are ultimately ubiquitous in the environment and have been found to pollute drinking water supplies. This is problematic due to their adverse health effects, most notably linked to birth defects, several types of cancer, and increased rates of autoimmune diseases.

Current methods for removing PFAS from water include filtration through granular activated carbon (GAC) or ion exchange (IX) resins. GAC is the most employed method of PFAS capture due to its low cost, but it is not without shortcomings. GAC captures long chain PFAS much better than short chain PFAS and has a stronger affinity for capturing sulfonic acid PFAS over the carboxylate PFAS. While IX resins are marginally better at capturing short chain PFAS than GAC, they still preferentially capture long chain PFAS over short chain PFAS. Additionally, IX resins (specifically anion exchange resins) are unable to capture any cationic or zwitterionic PFAS, which are a growing class that will require a different remediation technology. Both IX resins and GAC have shown greatly decreased PFAS capture when in the presence of competing ions or organic matter in water, making both options ineffective in many water matrices. Given the large amount and highly variable composition of PFAS used in industrial and commercial settings, materials that can absorb a wider range of PFAS compounds, including short chain and zwitterionic compounds, and in the presence of common interferents need to be developed.

High internal phase emulsion (HIPE) templating is a method for producing highly porous polymeric materials with varying properties that can depend on the choice of monomer and dopant. Based on the polymerization of the continuous phase with a high (>74%) volume ratio, polyHIPEs are prepared by emulsification of an aqueous monomer in an oil phase before polymerization and removal of the oil phase to achieve a highly porous polymeric network. Interconnected microporosity is an ideal form factor for an absorption media because it provides both the high surface area for binding and allows for passage of filtrate. The ability to tailor the functionality of the polymeric backbone has been demonstrated in polyHIPEs for conventional filtration and separation of metals and hydrocarbons but not for PFAS.

### SUMMARY OF THE INVENTION

Disclosed herein is a compound made by a process comprising copolymerizing a poly(ethylene glycol) acrylate with a first acrylate monomer. The first acrylate monomer comprises a first functional group. The first functional group interacts with a third functional group having a third functional group type selected from anionic groups, cationic groups, and perfluoroalkyl groups.

Also disclosed herein is a method comprising copolymerizing a poly(ethylene glycol) acrylate with a first acrylate monomer. The first acrylate monomer comprises a first functional group. The first functional group interacts with a third functional group having a third functional group type selected from anionic groups, cationic groups, and perfluoroalkyl groups.

### BRIEF DESCRIPTION OF DRAWINGS

A more complete appreciation will be readily obtained by reference to the following Description of the Example Embodiments and the accompanying drawings.

FIG. 1 shows example acrylic monomers.

FIG. 2 shows micrographs of polymers after synthesis.

FIG. 3 shows PFOA concentration in solution over time when exposed to the polyHIPE. NQ is no quaternary amine. C4, C6, and C8 is the carbon chain length attached to the quaternary amine functional group.

FIG. 4 shows PFOS concentration in solution over time when exposed to the polyHIPE.

FIG. 5 shows perfluorobutane sulfonic acid (PFBS) concentration in solution over time when exposed to the polyHIPE.

FIG. 6 shows perfluorobutanoic acid (PFBA) concentration in solution over time when exposed to the polyHIPE.

FIG. 7 shows perfluorononanoic acid (PFNA) concentration in solution over time when exposed to the polyHIPE.

FIG. 8 shows perfluorohexanoic acid (PFHxA) concentration in solution over time when exposed to the polyHIPE.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein are polymers made using high internal phase emulsion polymerization (polyHIPEs) specifically designed to capture per- and poly-fluoro alkyl substances (PFAS). The purpose is to capture a wide variety of PFAS from water matrices. The polymer is highly tunable and can have different additives and monomers included to specifically target the desired PFAS. The system is composed of acrylate and diacrylate polymers with various functional groups.

PolyHIPEs can be made with a variety of different monomers and functionalities that enable the specific binding of disparate PFAS. Leveraging the customizability of polyHIPEs allows for a high surface area material that is customized for PFAS absorption. PolyHIPEs were manufactured comprising a polyethylene glycol-based polymeric backbone for strength and durability, as well as water retention. A mixture of monomeric and/or dimeric species are added to functionalize and tune the polyHIPEs for PFAS absorption.

The compound is made by copolymerizing a poly(ethylene glycol) acrylate with a first acrylate monomer comprising a first functional group. Optionally, the copolymerization includes a second acrylate monomer comprising a second functional group. The first and second functional groups interact with a third functional group and a fourth functional group, respectively. The third and fourth functional groups would be those found in PFAS, including anionic groups, cationic groups, and perfluoroalkyl groups. When two acrylate monomers are used, they may interact with different types of PFAS groups. For example, the first acrylate monomer may interact with anionic groups and the second acrylate monomer may interact with perfluoroalkyl groups. Additional acrylate monomers may also be copolymerized, which interact with the same or different type as the first acrylate monomer or the second acrylate monomer (if present).

The copolymerization may be performed by any means. One suitable method is high internal phase emulsion polymerization, as described herein and as otherwise known in the art, to produce a porous composition. A porous composition may also be made by 3D printing. This composition may be contacted with a sample containing a per- or poly-fluoro alkyl substance and the per- or poly-fluoro alkyl substance allowed to adsorb to the composition. Example substances are perfluorooctanoic acid and perfluorooctane sulfonic acid.

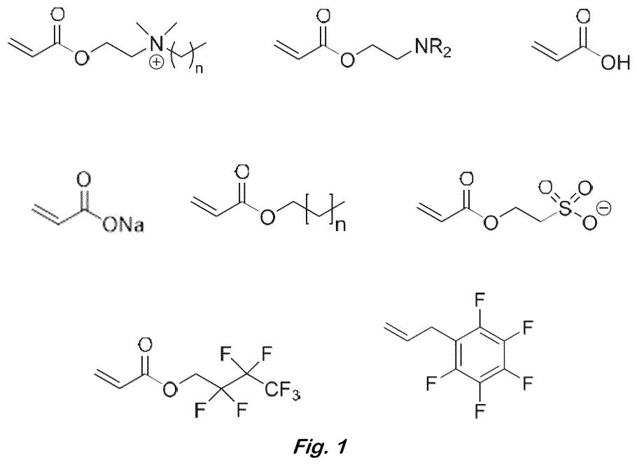

Example first and second functional groups include amine, quaternary amine, hydrogen, alkyl, thiol, cyclic alkyl, alkyl sulfonate, alkyl fluorocarbon, or aromatic fluorocarbon. Example acrylic monomers are shown in FIG. 1. R is an organic group and n is a positive integer.

This material affords a significant improvement in the ability of targeted PFAS adsorption. Mainly due to polyHIPEs exhibiting benefits of customizability, specificity, and durability over traditional sorbents. The polyHIPE can be customized to adsorb different PFAS while conventional methods such as GAC and IX resins lack specificity. Also, polyHIPE materials can be easily scaled unlike IX resins.

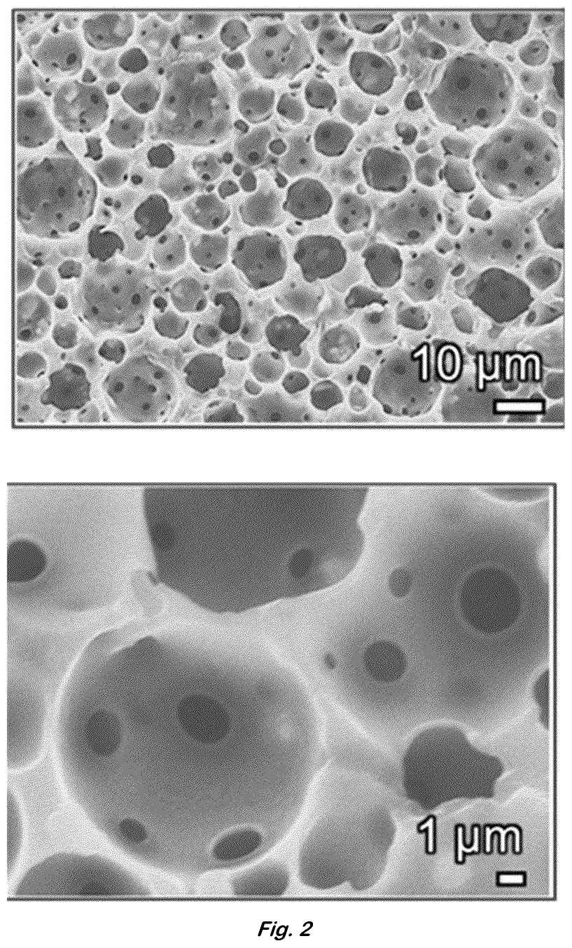

A sample synthesis proceeds as follows. Prior to emulsification, poly(ethylene glycol) diacrylate (PEGDA) and poly(ethylene glycol) methacrylate (PEGMA) were passed through basic alumina to remove any inhibitor. Sodium acrylate (122 mg), PEGDA (650 μL), PEGMA (200 μL), Pluronic F-127 (57 mg), kaolin (118 mg), lithium phenyl-2,4,6-trimethylbenzoylphosphinate (LAP) (30 mg), quaternary amine-acrylate (119 mg), ammonium persulfate (100 mg), and deionized water (1 mL) were placed in a 20 mL scintillation vial and vortexed for 1 min to disperse. Hexane (5 mL) was then added to the aqueous mixture, which was vortexed vigorously for an additional 2 min to form a HIPE. The mixture was placed in a speed mixer and mixed for 5 minutes at 3000 rpm. After thorough mixing, 3 drops of tetramethylethylenediamine (TMEDA) were added and the mixture was placed on the vortexer for 10 seconds. The HIPE was allowed to cure overnight at room temperature before being dried in oven at 50° C. for at least 4 hours to remove hexanes. In the example above quaternary amine acrylate was used, however, other monomers can be included. The monomers included and their loading in the polyHIPE determine both the amount of PFAS adsorbed and the type of PFAS. The monomers are acrylate based but vary in functional group with several examples shown in Table 1. Micrographs of an example polymer are shown in FIG. 2.

TABLE 1
Example monomers used in polyHIPE synthesis

| Monomers | R groups |
|---|---|
| 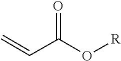 | R group can be amine, quaternary amine, hydrogen, alkyl, thiol, cyclic alkyl, alkyl sulfonate, alkyl fluorocarbons, and/or aromatic fluorocarbons |
| Example Monomers | PFAS Removal Mechanism |
| 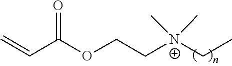 | Quaternary ammoniums: interacts with anionic head groups |
| 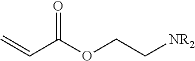 | Substituted amines: interacts with anionic head groups |
| 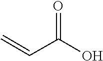 | Carboxylic acids/carboxylates: interacts with cationic head groups |
| 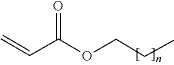 | Alkanes: interacts with perfluoro segments |
| 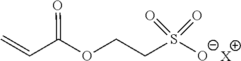 | Sulfonic acids/sulfonates: interacts with cationic head groups |
| 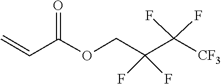 [SMILES: C=CC(=O)OCC(F)(F)C(F)(F)C(F)(F)F] | Alkyl fluorocarbons: interacts with perfluoro segments |
| 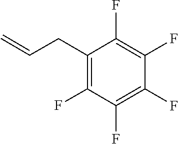 | Aromatic fluorocarbons: interacts with perfluoro segments |

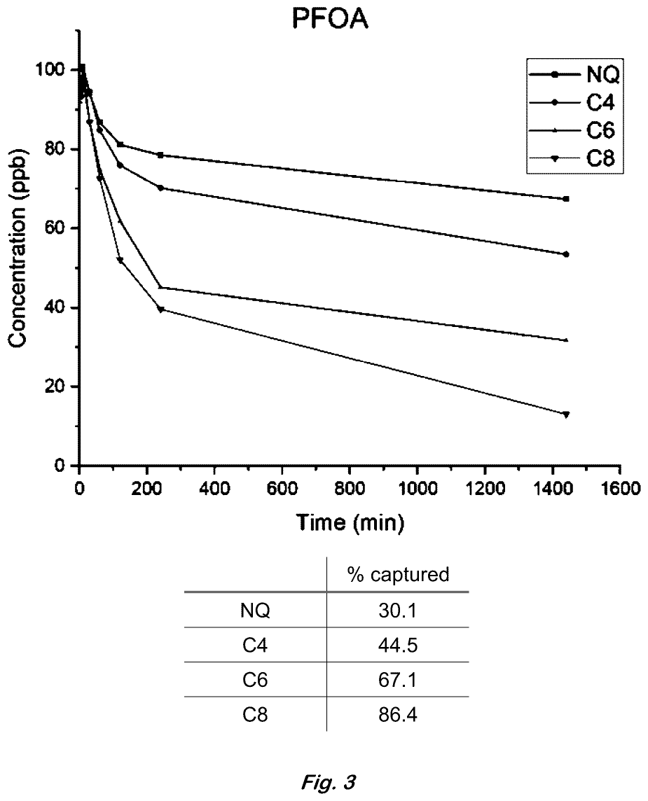

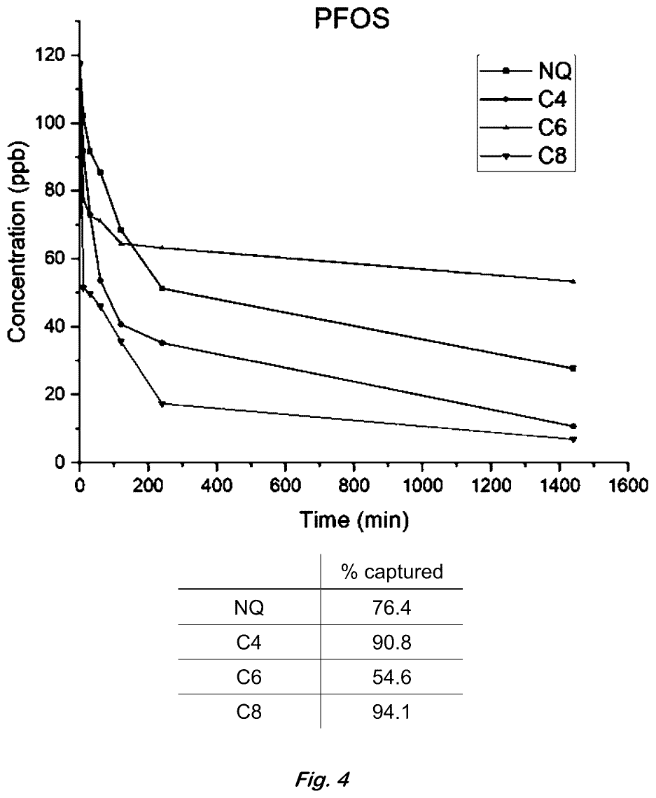

Batch tests were performed by adding 1 g of polyHIPE to 50 mL of a 100 ppb PFAS solution (5 μg of PFAS total). Samples were then collected over time to characterize PFAS absorption, which was quantified using liquid chromatography tandem mass spectrometry (LC-MS/MS). Perfluorooctanoic acid (PFOA) and perfluorooctane sulfonic acid (PFOS) were chosen as starting compounds as they are the most widely studied and tightly regulated PFAS. FIGS. 3 and 4 shows capture of PFOA and PFOS can be controlled by altering the functionalized polyHIPEs compared to a non-functionalized polyHIPE.

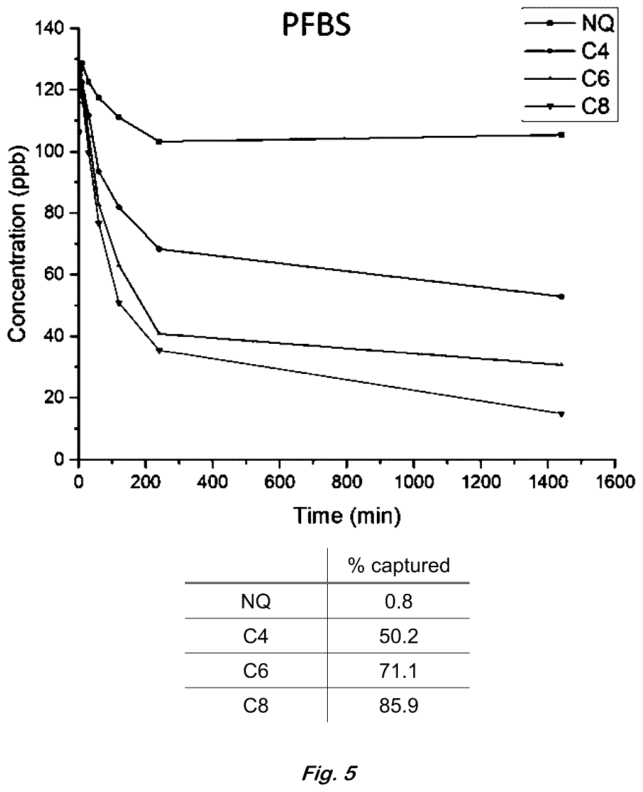

The polyHIPE with the simple modification of the addition of a C8 chain quaternary amine captured >90% of PFOA and PFOS from water within 24 hours. These experiments were expanded to several other PFAS to demonstrate that polyHIPE materials can be customized to apply to capture a wide range of PFAS. As shown in FIG. 5, PFBS, a short chain PFAS, is captured nearly as effectively as the longer chain PFAS (PFOS and PFOA), with the C8 quaternary amine functionalized polyHIPE capturing 86% at 24 hours (Table 2).

TABLE 2
Common PFAS and the amount of each PFAS the C8 quaternary
amine functionalized polyHIPE captured from solution at 24 hours.

| | | Chain | % captured |
|---|---|---|---|
| Sub Class | Compound | Length | in 24 hr |
| Perfluoro alkyl | PFBA | 4 | 74.7 |
| carboxylic acids | PFHxA | 6 | 65.7 |
| (PFCAs) | PFOA | 8 | 86.4 |
| | PFNA | 9 | 92.1 |
| Perfluoro alkyl sulfonic | PFBS | 4 | 85.9 |
| acids (PFSAs) | PFOS | 8 | 94.1 |

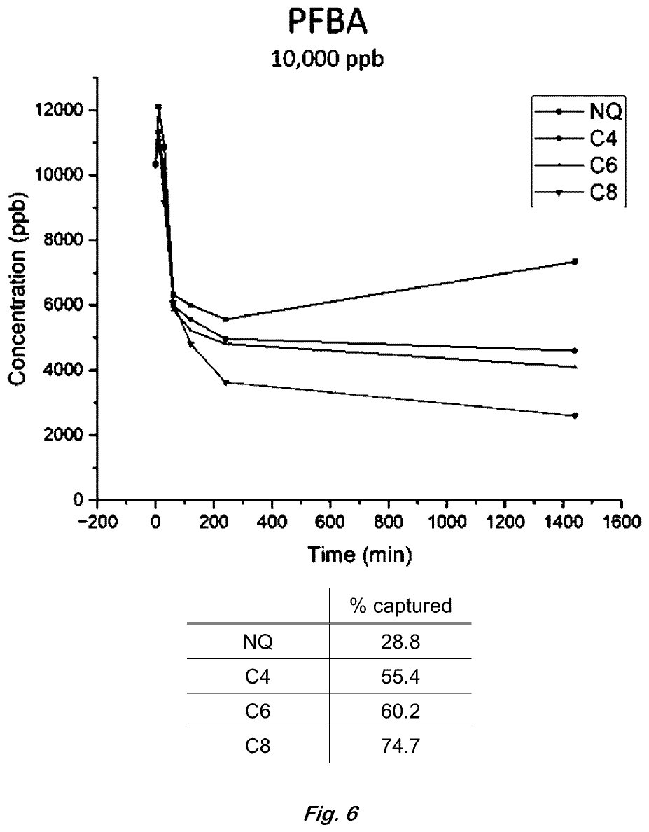

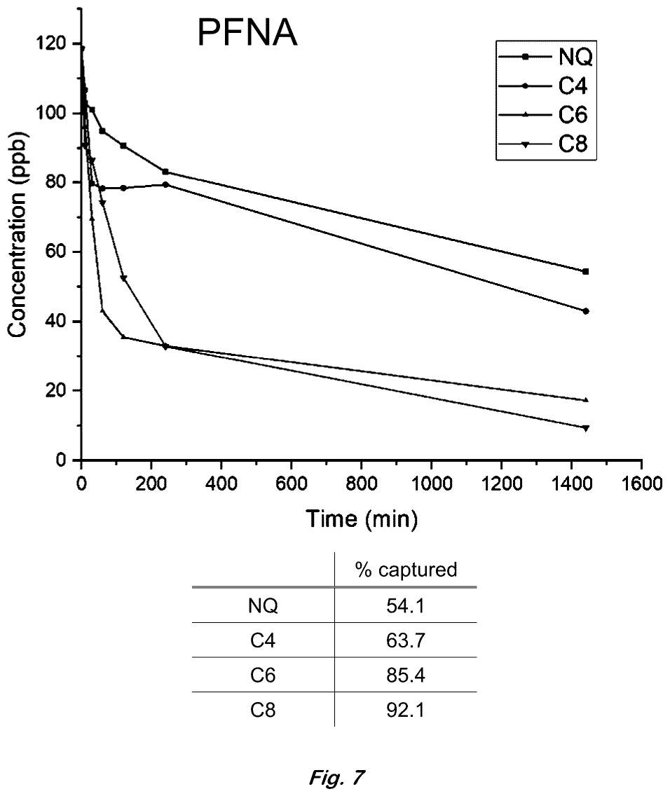

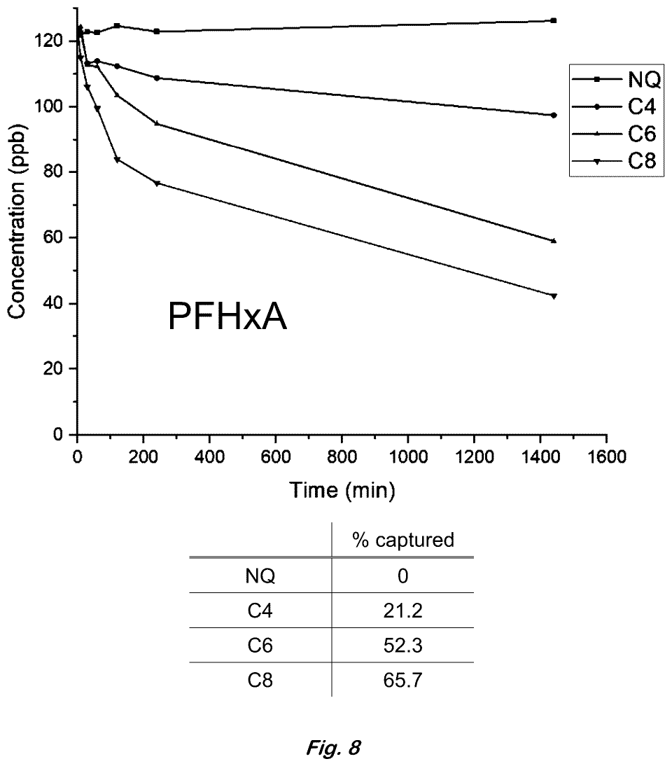

The effect of concentration on PFAS capture rates was also explored. It was found that the functionalized polyHIPEs can effectively remove PFAS from water at various concentrations. When exposed to PFAS at much higher concentrations (500 μg PFBA in FIG. 6) initial capture of the PFAS occurs much quicker. In this instance, approximately 50% of the PFAS was captured within the first hour. However, the C8 quaternary amine continued to capture PFAS well after the first hour and still out performed the polyHIPEs functionalized with the shorter chain quaternary amines. This additionally demonstrates that the quaternary amine functionalized polyHIPE is capable of capturing short chain PFAS, with the C8 quaternary amine polyHIPE capturing 75% of the PFBA in 24 hours. Concentration graphs for PFNA and PFHxA are shown in FIGS. 7 and 8.

The polyHIPEs have high gel fraction making them resistant to organic solvents while retaining a large swelling ratio in water, as shown in Table 3. The structure provides both surface area for PFAS adsorption and allow passage of filtrate and contaminates.

TABLE 3
Gel fraction and swelling results for the various polyHIPEs

| Sample | Gel Fraction | Swelling |
|---|---|---|
| No quat | 98.0 ± 1.2% | 575 ± 39% |
| C4 | 93.8 ± 1.0% | 584 ± 22% |
| C6 | 100.7 ± 0.7% | 574 ± 43% |
| C8 | 100.2 ± 0.2% | 563 ± 15% |

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A compound made by a process comprising:
copolymerizing a poly(ethylene glycol) acrylate with a first acrylate monomer;
wherein the first acrylate monomer comprises a first functional group;
wherein the first functional group interacts with a third functional group having a third functional group type selected from anionic groups, cationic groups, and perfluoroalkyl groups.

2. A composition comprising:
the compound of claim 1;
wherein the copolymerization is performed by high internal phase emulsion polymerization.

3. A method comprising:
contacting the composition of claim 2 with a sample containing a per- or poly-fluoro alkyl substance; and
allowing the per- or poly-fluoro alkyl substance to adsorb to the composition of claim 2.

4. The method of claim 3, wherein the per- or poly-fluoro alkyl substance is perfluorooctanoic acid or perfluorooctane sulfonic acid.

5. The compound of claim 1, wherein the first functional group is amine, quaternary amine, hydrogen, alkyl, thiol, cyclic alkyl, alkyl sulfonate, alkyl fluorocarbon, or aromatic fluorocarbon.

6. The compound of claim 1, wherein the first acrylic monomer is 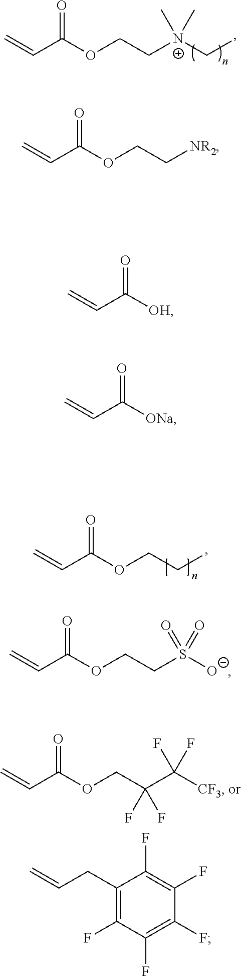
wherein n is a positive integer; and
wherein R is an organic group.

7. The compound of claim 1;
wherein the copolymerization includes a second acrylate monomer;
wherein the second acrylate monomer comprises a second functional group;
wherein the second functional group interacts with a fourth functional group having a fourth functional group type selected from anionic groups, cationic groups, and perfluoroalkyl groups;
wherein the third functional group type and the fourth functional group type are different.

8. A composition comprising:
the compound of claim 7;
wherein the copolymerization is performed by high internal phase emulsion polymerization.

9. A method comprising:
contacting the composition of claim 8 with a sample containing a per- or poly-fluoro alkyl substance; and
allowing the per- or poly-fluoro alkyl substance to adsorb to the composition of claim 8.

10. The method of claim 9, wherein the per- or poly-fluoro alkyl substance is perfluorooctanoic acid or perfluorooctane sulfonic acid.

11. The compound of claim 7, wherein the second functional group is amine, quaternary amine, hydrogen, alkyl, thiol, cyclic alkyl, alkyl sulfonate, alkyl fluorocarbon, or aromatic fluorocarbon.

12. The compound of claim 7, wherein the second acrylic monomer is 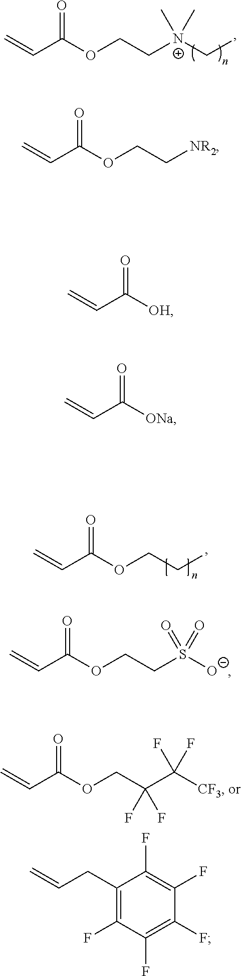
wherein n is a positive integer; and
wherein R is an organic group.

13. A method comprising:
copolymerizing a poly(ethylene glycol) acrylate with a first acrylate monomer;
wherein the first acrylate monomer comprises a first functional group;
wherein the first functional group interacts with a third functional group having a third functional group type selected from anionic groups, cationic groups, and perfluoroalkyl groups.

14. The method of claim 13, wherein the copolymerization is performed by high internal phase emulsion polymerization.

15. The method of claim 13, wherein the first functional group is amine, quaternary amine, hydrogen, alkyl, thiol, cyclic alkyl, alkyl sulfonate, alkyl fluorocarbon, or aromatic fluorocarbon.

16. The method of claim 13, wherein the first acrylic monomer is 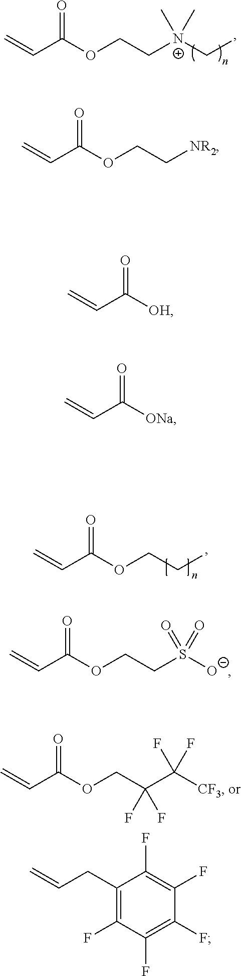
wherein n is a positive integer; and
wherein R is an organic group.

17. The method of claim 13;
wherein the copolymerization includes a second acrylate monomer;
wherein the second acrylate monomer comprises a second functional group;
wherein the second functional group interacts with a fourth functional group having a fourth functional group type selected from anionic groups, cationic groups, and perfluoroalkyl groups;
wherein the third functional group type and the fourth functional group type are different.

18. The method of claim 17, wherein the copolymerization is performed by high internal phase emulsion polymerization.

19. The method of claim 17, wherein the second functional group is amine, quaternary amine, hydrogen, alkyl, thiol, cyclic alkyl, alkyl sulfonate, alkyl fluorocarbon, or aromatic fluorocarbon.

20. The method of claim 17, wherein the second acrylic monomer is 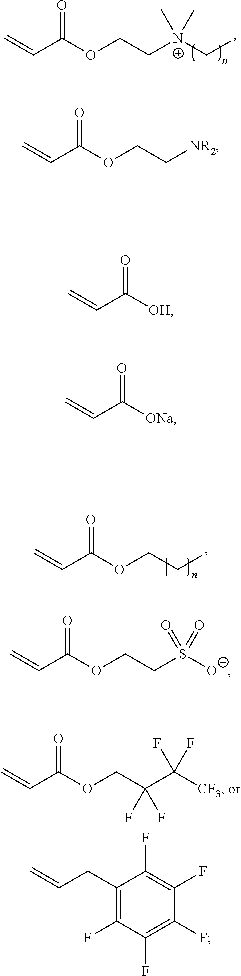
wherein n is a positive integer; and
wherein R is an organic group.
